(19) United States
(12) Patent Application Publication
(10) Pub. No.: US 2004/0122914 A1
(43) Pub. Date: Jun. 24, 2004

(54) Secure data backup communications system

(76) Inventor: John Williams, White Plains, NY (US)

Correspondence Address: LAW OFFICES OF ADAM H. JACOBS, SUITE 726, 1904 FARNAM STREET, OMAHA, NE, 68102, US

(21) Appl. No.: 10/725,639

(22) Filed: Dec. 2, 2003

Related U.S. Application Data
(60) Provisional application No. 60/430,188, filed on Dec. 2, 2002.

(51) Int. Cl. G06F 12/16; G06F 15/16

(52) U.S. Cl. 709/217; 711/162

(57) ABSTRACT

A secure data backup communications system for providing remote secure data storage for connected user systems in the event of loss of on-site original or backup data includes a remote backup central communications and storage facility operative to receive and store backup electronic data in an accessible data storage system and a generally independent and generally secure information transmission communication system separate from utility-based communications networks, the information transmission communication system extending between and connecting the remote backup central communications and storage facility and a connected user system of the secure data backup communications system. A receiving interface device and a transmitting interface device transfer data to a secure data storage system within the remote backup central communications and storage facility to securely store transmitted backup data in the storable data format received via the receiving interface means therewithin until retrieved via the transmitting interface means.

### CROSS-REFERENCE TO RELATED PROVISIONAL PATENT

This application claims priority based on a provisional patent, specifically on the Provisional Patent Application Serial No. 60/430,188 filed Dec. 2, 2002.

### BACKGROUND OF THE INVENTION

1. Technical Field

The present invention is related to secure data backup communications systems and, more particularly, to a nationwide, regional and/or local secure data backup communications system which includes redundant communication systems connecting a plurality of external data storage facilities to at least one centralized operations command center or headquarters which is designed to withstand both natural and man-made disasters to maintain generally continuous data transfer communications regardless of the external conditions such as disaster or other such data-jeopardizing situation.

2. Description of the Prior Art

Secure data transmission and storage is an ongoing concern for both businesses and government. Specifically, many companies and branches of government lack a secure data storage location or locations in which important data may be stored. Instead, these organizations often rely on in-house data storage devices or external servers for the storage of data, without being completely sure of the security of the facility if faced with a disaster of some kind, such as fire, flood, or a man-made disaster such as a nuclear explosion or other such catastrophic event. In many circumstances, the data will be lost during such an event, which eliminates the usefulness and value of the backup data. There is therefore a need for a secure data backup system and facility which will result in the survival of backup data transmitted thereto.

The need for secure data backup facilities is exacerbated by the increase in worldwide terrorist activities, which eventually will hit not only physical structures and persons, but electronic media in which much of the world's information is stored. At the present time, only the largest entities can afford to design and construct secure data backup facilities, and the-remaining entities are left to protect their data in whatever reasonably acceptable method that they can afford. While such backup systems will provide reasonable data protection and integrity, in the event of a major disaster or the like, the data will almost certainly be lost. There is therefore a need for a secure data backup communications system which is usable by almost any entity regardless of size and location, thereby permitting secure and efficient storage of data.

Therefore, an object of the present invention is to provide an improved secure data backup communications system.

Another object of the present invention is to provide a secure data backup communications system which includes a generally independent and secure communications system which functions independent of the standard communications web to ensure secure backup data transfer in a disaster environment.

Another object of the present invention is to provide a secure data backup communications system which is usable by companies and individuals both large and small, thus providing secure data backup for those entities which ordinarily would not be able to access such a system.

Another object of the present invention is to provide a secure data backup communications system which can be used to supplement existing backup systems which are on-site, thereby providing needed backup for data in an easily accessible off-site location via a high-capacity data transfer communications system, one which is not available at present.

Another object of the present invention is to provide a secure data backup communications system which will provide data restore capability during times of extreme duress.

Finally, an object of the present invention is to provide a secure data backup communications system which is efficient, safe and durable in use.

### SUMMARY OF THE INVENTION

The present invention provides a secure data backup communications system for providing remote secure data storage for connected user systems in the event of loss of on-site original or backup data which includes a remote backup central communications and storage facility operative to receive and store backup electronic data in an accessible data storage system and a generally independent and generally secure information transmission communication system separate from utility-based communications networks, the generally independent and generally secure information transmission communication system extending between and connecting the remote backup central communications and storage facility and a connected user system of the secure data backup communications system. A receiving interface device is operative to receive transmitted backup data from a connected user system and optionally translate the transmitted backup data to a storable data format for retrievable storage thereof, and a transmitting interface device is operative to retrieve the transmitted backup data and optionally translate the transmitted backup data from the storable data format to a user system data format for transmitting the transmitted backup data back to a connected user system via the generally independent and generally secure information transmission communication means once the remote user system requests the stored transmitted backup data. Finally, a secure data storage system within the remote backup central communications and storage facility is in information transmission connection with the receiving interface device and the transmitting interface device, the secure data storage system operative to securely store transmitted backup data in the storable data format received via the receiving interface device therewithin until retrieved via the transmitting interface device.

The secure data backup communications system as thus described clearly offers several advantages over those systems found in the prior art. For example, particularly in light of the 9/11 tragedy and the potential for terrorist attacks at any time and at any place, there is no guarantee that the present data backup systems used by companies and governmental entities will be able to deal with the stresses of such an attack, which would likely result in at least a partial loss of the backup data being stored therein. Furthermore, at the present time there is no easily accessible secure data backup communications system which can be used by multiple organizations, some of which would not be able to afford the large costs of constructing their own secure data backup facility. Also, because the communications system of the present invention is generally independent and secure as compared to the standard communication networks used by local data transmission networks, the chances are far greater that the communications network of the present invention will survive a catastrophe intact enabling continuous transfer of backup data between the connected user systems and the remote backup central communications and storage facility of the present invention. The present invention thus provides a substantial improvement over those backup data storage systems found in the prior art.

### BRIEF DESCRIPTION OF THE DRAWING

FIG. 1 is a flow diagram showing the general system description of the secure data backup communications system of the present invention.

### DESCRIPTION OF THE PREFERRED EMBODIMENT

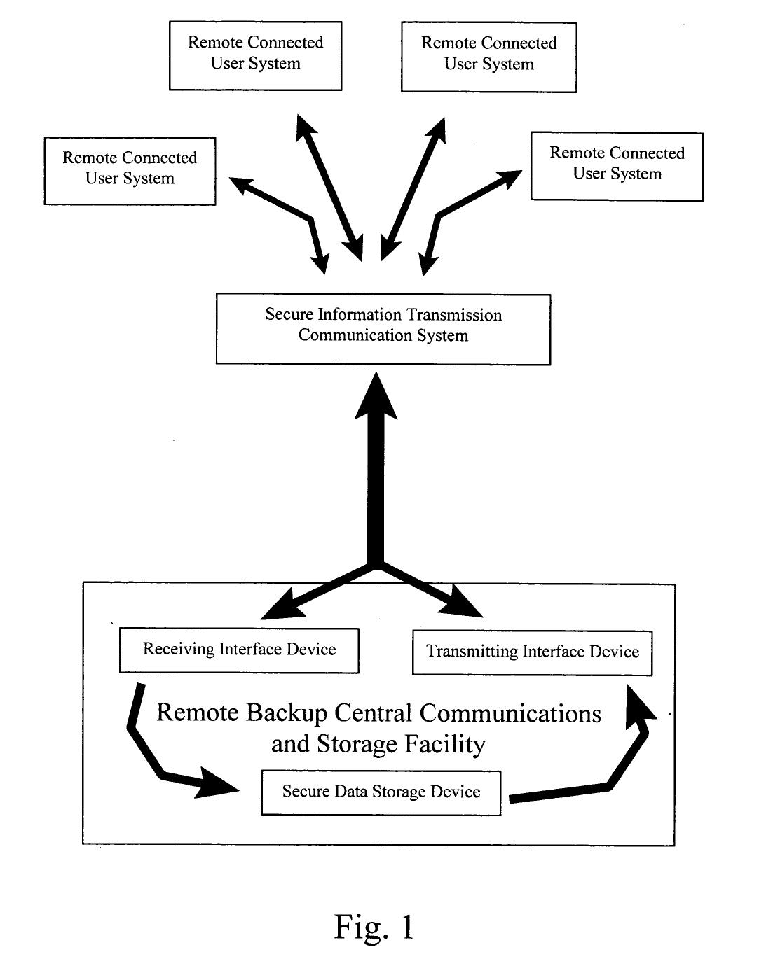

The secure data backup communications system of the present invention is shown best in FIG. 1 as including at its core a main national headquarters which is located in a facility with comprehensive military-style protection and security from all forms of disaster and threats including but not limited to physical, electronic, chemical, biological, nuclear and radiological events, thus rendering the main national headquarters generally impervious to all but the most exceptional disaster. The main headquarters may also be referred to as the remote backup central communications and storage facility to further illustrate the intended functionality of the headquarters, although such renaming is certainly not critical to the present invention. Furthermore, although such a headquarters may be located in any appropriate community, it is preferred that the headquarters be centrally located in the United States in an area of the country which is not earthquake-prone in order to insure the integrity of the headquarters. It has been found that the Omaha, Nebr. metropolitan area offers an exceptionally well-located and well-prepared metropolitan community for such a headquarters, although it is to be expected that numerous regional command centers would be located in metropolitan areas around the country, each of which would be in guaranteed communications via the redundant communication systems with the main headquarters to ensure secure and accurate data transfer and storage in the event of a disaster regardless of the location around the country.

The main headquarters would utilize backbone communications trunks, including landline, fiber optic, microwave, UHF and VHF broadcasting facilities and other radio and satellite technologies to maintain communication between the main headquarters and regional headquarters and business and government agencies. It should be noted that the term “redundant” as used in this disclosure refers to these multiple backup communication systems, and not in merely a general way to currently available communication and data transmission systems. This broad array of communications infrastructure exists (in many ways, uniquely) in the Omaha, Nebr. metropolitan area. Of course, it is preferred that the regional command centers each be protected in a facility similar to that used in connection with the main national headquarters with comprehensive military-style protection and security from all forms of disaster and threats including but not limited to physical, electronic, chemical, biological, nuclear and radiological events, thus rendering the regional headquarters generally impervious to all but the most exceptional disaster. One way to envision the main and regional headquarters system is to think of it as a “hub and spoke” system, with the main headquarters in communications connection with each of the regional headquarters and each of the regional headquarters in communications connection with the businesses and government branches and agencies, although it should be noted that some direct connections between the main headquarters and businesses and government branches and agencies may be desirable to ensure uninterrupted data transmission and storage capabilities.

It is important to note that the secure data backup communications system of the present invention is intended to supplement those data backup systems already in existence around the country but which, for various reasons, cannot be updated or made redundant. The main headquarters will be staffed and operated twenty-four hours a day, seven days a week, in order to be available for any disaster occurrence and in any situation. In fact, the main headquarters and to a lesser extent the regional headquarters may also include in-house living facilities for the on-site staff to permit the staff to always be on call in case of an emergency. It is expected that the headquarters staff will be highly trained and familiar with each of the organization's needs to which they are assigned in order to insure proper and quick response to any incoming data transfer.

At the heart of the present inventions are the redundant communication systems, facilities, and technologies which connect the main headquarters and regional headquarters to existing businesses and government branches and agencies, thus providing seamless connectivity in the event that one or more of the organization's primary backup systems becomes inoperable or destroyed. The secure data backup communications system of the present invention includes interfaced technologies which permit the main headquarters and the regional headquarters to connect with a variety of data storage and communication systems for the businesses and government branches and agencies, as well as various technologies to insure compatibility with various computer systems for receipt and storage of data. However, it is important to note that as there is not a universal data storage system used by each and every one of the businesses and governmental agencies currently in operation, an important component of the present invention is the ability to interface with those different data storage systems to ensure that secure data transfer for backup purposes is maintained.

It is expected that the present invention will utilize available data storage technology such as server units, hard drives, tape storage units and the like for storage of incoming data, although the exact nature of the storage technology is not critical so long as the functional features of the present invention are maintained. Specifically, these functional features are that the data storage be quickly and efficiently performed in the secure data storage facility and that all data be kept confidential between users of the present invention to ensure that the system is reliable and safe in use.

An important feature of the present invention is that the secure data backup communications system is designed for use with both military and civil data storage and transmission systems on all levels, including local, state and federal governmental entities. A major problem with current data storage systems is that they are intentionally designed not to communicate with other databases and storage facilities to ensure confidentiality of the data stored therein. The critical difference between current data storage facilities and the secure data backup communications system of the present invention is that the current data storage facilities are microsystems, in that they are only designed and used with specific businesses and government branches and agencies, whereas the present invention is a macrosystem in that it is designed not only to communicate with local business and governmental entities, but to receive and securely store data from regional and national business and governmental entities also.

Of course, it is to be understood that numerous modifications, substitutions and additions may be made to the secure data backup communications system described herein. For example, the exact implemented features and functional characteristics of the features described above may be changed or modified so long as the intended functionality of providing a redundant secure data backup communications system is maintained. Additionally, the precise location and characteristics of the national and regional headquarters described herein may be changed or modified so long as the functionality of the headquarters, be it local, regional or national, is not impaired. Finally, modification of the communication systems based on improved technology is expected and will not affect the functionality of the system contained herein.

There has thus been shown and described an secure data backup communications system which fulfills all of its intended objectives.

I claim:

1. A secure data backup communications system for providing remote secure data storage for connected user systems in the event of loss of on-site original or backup data comprising:
a remote backup central communications and storage facility operative to receive and store backup electronic data in an accessible data storage system;
generally independent and generally secure information transmission communication means separate from utility-based communications networks, said generally independent and generally secure information transmission communication means extending between and connecting said remote backup central communications and storage facility and a connected user system of said secure data backup communications system;
receiving interface means operative to receive transmitted backup data from a connected user system and optionally translate the transmitted backup data to a storable data format for retrievable storage thereof;
transmitting interface means operative to retrieve said transmitted backup data and optionally translate said transmitted backup data from said storable data format to a user system data format for transmitting said transmitted backup data back to a connected user system via said generally independent and generally secure information transmission communication means; and
secure data storage means within said remote backup central communications and storage facility in information transmission connection with said receiving interface means and said transmitting interface means, said secure data storage means operative to securely store transmitted backup data in said storable data format received via said receiving interface means therewithin until retrieved via said transmitting interface means.

2. The secure data backup communications system of claim 1 wherein said remote backup central communications and storage facility is generally impervious to externally-based operational disruptions to facilitate generally uninterruptible exchange of stored transmitted backup data between connected remote user systems and said remote backup central communications and storage facility.

3. The secure data backup communications system of claim 1 wherein said receiving interface means is further operative to receive incoming transmitted backup data, identify the specific user system data format of said incoming transmitted backup data, translate as necessary said incoming transmitted backup data into said storable data format generally free of significant modification of the informational content of said incoming transmitted backup data and forward said incoming transmitted backup data to said secure data storage means within said remote backup central communications and storage facility.

4. The secure data backup communications system of claim 1 wherein said transmitting interface means is further operative to receive outgoing transmitted backup data in said storable data format from said secure data storage means within said remote backup central communications and storage facility, identify the original specific user system data format of said outgoing transmitted backup data when received as incoming transmitted backup data, translate as necessary said outgoing transmitted backup data into said original specific user system data format generally free of significant modification of the informational content of said outgoing transmitted backup data and forward said outgoing transmitted backup data to the connected user system requesting said outgoing transmitted backup data.

5. The secure data backup communications system of claim 1 wherein said secure data storage means within said remote backup central communications and storage facility further comprises at least one electronic data storage device.

6. The secure data backup communications system of claim 1 wherein said generally independent and generally secure information transmission connection between said remote backup central communications and storage facility and remote connected user systems is selected from the group comprising landline, fiber optic, microwave, radio communications, satellite communications and cable.

7. A method of providing a secure data backup communications system for providing remote secure data storage for connected user systems in the event of loss of on-site original or backup data, said method comprising the steps:
providing a remote backup central communications and storage facility operative to receive and store backup electronic data in an accessible data storage system;
providing a generally independent and generally secure information transmission communication means separate from utility-based communications networks, said generally independent and generally secure information transmission communication means extending between and connecting said remote backup central communications and storage facility and a connected user system of said secure data backup communications system;
providing receiving interface means operative to receive transmitted backup data from a connected user system and optionally translate the transmitted backup data to a storable data format for retrievable storage thereof;
providing transmitting interface means operative to retrieve said transmitted backup data and optionally translate said transmitted backup data from said storable data format to a user system data format for transmitting said transmitted backup data back to a connected user system via said generally independent and generally secure information transmission communication means;
providing secure data storage means within said remote backup central communications and storage facility in information transmission connection with said receiving interface means and said transmitting interface means;
receiving said transmitted backup data from a connected user system via said generally independent and generally secure information transmission communication means;
analyzing said transmitted backup data via said receiving interface means to determine the data format of said transmitted backup data;
translating said transmitted backup data via said receiving interface means into a storable data format generally free of significant modification of the informational content of said transmitted backup data;
storing said translated transmitted backup data in said secure data storage means;
transmitting said translated transmitted backup data from said secure data storage means to said transmitting interface means upon receiving a request for transmittal thereof from the specific connected user system;
translating said translated transmitted backup data by said transmitting interface means to the original data format detected via said receiving interface means for compatibility with the specific connected user system; and
transmitting said transmitted backup data to the specific connected user system via said generally independent and generally secure information transmission communication means thereby providing requested backup data to the specific connected user system.
